(19) United States
(12) Patent Application Publication
(10) Pub. No.: US 2023/0002625 A1
(43) Pub. Date: Jan. 5, 2023

(54) A NOVEL COMPOSITION FOR REDUCING INDOOR POLLUTION AND A METHOD THEREOF

(71) Applicant: DB LIFESCIENCES LLP, Haryana (IN)

(72) Inventors: VIVEK BHATNAGAR, Haryana (IN); ALLAAN KORTEGAARD SCHMIDT, Gadstrup (DK)

(21) Appl. No.: 17/790,124

(22) PCT Filed: Dec. 30, 2020
(86) PCT No.: PCT/IN2020/051066

§ 371 Date: Jun. 30, 2022

(30) Foreign Application Priority Data
Dec. 30, 2019 (IN) 201911054554

(51) Int. Cl. C09D 7/43; C09D 171/12; C09D 7/63; C09D 5/00

(52) U.S. Cl. CPC C09D 7/43; C09D 171/12; C09D 7/63; C09D 5/008

(57) ABSTRACT

The current invention relates to a novel water-soluble, biodegradable, non-toxic, composition, and methods thereof, for reducing indoor and outdoor pollution of ambient air that is in proximity to a surface coated with the disclosed composition. The disclosed particle-binding composition comprises di- and trivalent alcohols, at least one thickener, at least one short chain triglyceride, and optionally, at least one additive.

### FIELD OF INVENTION

The present invention relates to a novel environment friendly non-toxic particle coating formulation. The current invention more specifically relates to methods and compositions for reducing pollutants in ambient air, specifically ambient air that is in proximity with surfaces coated with the formulation disclosed herein.

### BACKGROUND

Most of the developing countries are high pollution risk countries, including outdoor and indoor pollution. Combined with high population in small areas, this pollution takes a heavy toll on mental and physical well-being and also reduces the lifespan of people exposed to such heavy pollution loads.

Polluted environment with poor air quality has a huge negative impact on both the physical and mental health. Indoor as well as outdoor pollution can adversely affect health, which in turn can affect mortality rate, quality of living, performance and learning. The most common symptoms of poor air quality are irritation to the eyes, nose and throat, coughing and fatigue, headache, sensory discomfort in the form of odor nuisances, light discomfort and temperature discomfort, exacerbated respiratory allergies, including hay fever symptoms, and increased frequency of respiratory tract infections, allergic bronchitis and reactions to pollution leading to various chronic illnesses and Chronic Obstructive Pulmonary Disease (COPD). Pollution continues to increase in most of the developing, and many developed countries.

Moreover, children may be affected in a different and to a greater extent than adults, because pollution may affect their development curve. Ensuring better air quality in schools can result in students and teachers being more proficient, more productive and having lesser sickness intervals.

There is great potential in ensuring a healthier and less polluted indoor environment in all enclosed as well as outdoor areas. Lesser pollution in indoor areas benefits not only people who are sensitive and have a low immunity, but in general increases the quality of life for everybody. The air quality in schools, and many places with heavy indoor activity, and human footfall, in most of the developing countries is not monitored, and in absence of any government recommendations, a decrease in pollution levels can have a great positive effect on the health, concentration and performance of people. The above problem applies to all indoor environments, that is, offices, restaurants, hotels, hospitals, all types of production units, that can have extremely poor air quality, depending on many factors such as the air filtration systems, footfall, number of people working in a specific area, geography of the region etc.

Moreover, house dust allergy is highly prevalent and can cause clogged, itchy or runny nose, besides respiratory distress. Moreover, house dust mite allergy is a year-round disease. People who suffer from house dust mite allergy often feel tired and sluggish. Also, it is difficult to sleep and you often wake up in the night due to difficulty breathing. Many people snore and become dry in the mouth and throat, or they wake up coughing.

The current known and used methods for reducing indoor and outdoor pollution are usually expensive, and have limited area coverage, usually require heavy load of electricity, and replacement of filters frequently, which can turn out to be very expensive in the long run. Moreover, such measures are usually not available to low socio-economic populations.

The current invention obviates the problems stated above and reduces indoor and outdoor pollution to a significant extent and thereby improves the quality of life. The invention provides a novel environment friendly, non-toxic, biodegradable particle binding composition for reducing indoor and outdoor pollution.

The current disclosure relates to a novel composition that can reduce indoor as well as outdoor pollution, is non-toxic and non-hazardous, inexpensive compared to other ways of reducing ambient air pollution and is easily applicable to even low-income, and low-socioeconomic regions. Thus, the composition disclosed herein can improve the quality of life for people being exposed to poor air quality in outdoor and/or indoor settings.

### SUMMARY

The current invention discloses a novel water soluble, non-toxic, biodegradable, particle-binding composition. The invention particularly relates to compositions and methods of reducing pollution in ambient air.

One embodiment of the current invention is a water-soluble, particle binding composition comprising 10% to 90% w/w of di- and trivalent alcohols, 0.1 to 10% w/w of at least one thickener , 1 to 10% w/w of at least one short chain triglyceride, and optionally, 0.1 to 50% w/w of at least one additive.

In one embodiment, the composition further comprises water as a diluent.

In one embodiment, pH of the composition disclosed herein is in the range 5.5-7.

In one embodiment, the composition comprises a thickener, and the thickener is C10-C30 alkyl acrylate cross-polymer. In one embodiment, the thickener is neutralized with a neutralizer.

In one embodiment, the neutralizer is selected from the group consisting of triethanolamine, 2-amino-2-methyl-1-propanol, tetrahydrozypropyl ethylenediamine, sodium hydroxide, and di isopropanolaminc.

In one embodiment, the neutralizer is 2-amino-2-methyl-1-propanol.

In one embodiment, the composition is non-toxic to humans and animals.

In one embodiment, the composition disclosed herein is stable for at least 12 months, 24 months, or 36 months after formulation. In one embodiment, the composition disclosed herein maintains its homogeneity, without separating into different phases, for at least 12 months, 24 months, or 36 months after formulation. In one embodiment, the composition binds particles in range of size 0.5-20 microns. In one embodiment, the composition is applied as at least as one coating on a surface to reduce pollution of ambient air in proximity to the surface. In one embodiment, the at least one coating is removed and replaced by a fresh coating on the surface after 16-70 hours. In one embodiment, the coating may be effective till 1 day, 2 days, 3 days, 4 days, 5 days, 6 days or 7 days. In one embodiment, the at least one coating is at least 0.02 microns thick. In one embodiment, the at least one coating is 0.02-2 microns thick. In one embodiment, the at least one coating is removed by applying a water-based cleaning agent. In one embodiment, the at least one coating is removed by applying only water.

In one embodiment, the composition disclosed herein reduces pollution of ambient air in proximity to a surface coated by the composition.

In one embodiment, the composition disclosed herein reduces pollution of ambient air in proximity to a surface coated by the composition by binding and reducing movement of particles that come in contact with the coated surface. In one embodiment, the coated surface can be horizontal or vertical. In one embodiment, the coating is done on the floor. In one embodiment, the coating is done on the wall.

In one embodiment, the composition reduces pollution of ambient air till up to a height, or distance of two meters from the surface that has been coated with the said composition. In one embodiment, the composition reduces pollution of ambient air till up to a height of two meters from the horizontal surface that has been coated with the said composition. In one embodiment, the surface is made of any natural or man-made material, or a combination thereof.

In one embodiment, the surface is made of at least one natural material and the natural material is wood, bamboo, rubber, linoleum, cork, marble, granite, limestone, slate, or a combination thereof.

In one embodiment, the surface is made of at least one man-made material and the man-made material is vinyl, glass, leather, epoxy, cement, concrete or a combination thereof.

In one embodiment, the composition disclosed reduces pollution of ambient air in proximity to the coated surface by up to 90%, when applied at a frequency of at least one coating every 16-70 hours. In one embodiment, the composition disclosed reduces pollution of ambient air in proximity to the coated surface by up to 85%, when applied at a frequency of at least one coating every 16-70 hours. In one embodiment, the frequency of coating may change depending on the type of surface being coated, and the activity level in the ambient air proximal to the surface. In one embodiment, the frequency of coating might be once every one day, once every two days, once every three days, once every four days, once every five days, once every six days, or once every seven days. The coating may also be reapplied at frequency of less than one day, if there is high activity in the air ambient to the coated surface, or if the surface is collecting particulate matter at a high rate.

In one embodiment, the particles are indoor or outdoor allergens.

In one embodiment, the indoor allergens are dust mites.

In one embodiment, the pollutants are aerosols.

In one embodiment, the particle binding composition disclosed herein decreases pathogen load in the ambient inhaled air. In one embodiment, composition reduces the pathogen load in the ambient air by binding the particulate matter and aerosols to which the pathogens may bind, and preventing the particulate matter and aerosols from floating up again due to activity and/or movement of ambient air.

In one embodiment, the pathogens are virus particles. In one embodiment, the pathogens are bacteria. In one embodiment, the pathogens encompass any pathogen that may be transmitted by respiratory route.

One embodiment of the current invention is a method of reducing pollution of ambient air, the method comprising the steps of applying at least one coating of a water-soluble, particle-binding composition to a surface in proximity to the ambient air, wherein the composition comprises 10% to 90% w/w of di- and trivalent alcohols, 0.1 to 10% w/w of at least one thickener, 1 to 10% w/w of at least one short chain triglyceride, and optionally, 0.1 to 50% w/w of at least one additive.

In one embodiment, the method further comprises the step of removing the coating from the surface and reapplying a fresh coating after a period of 16-70 hours. In one embodiment, the coating is reapplied at least once every 24 hours, every 48 hours, every 60 hours or every seventy hours.

### BRIEF DESCRIPTION OF FIGURES

FIG. 1 shows the graph depicting dust levels at location 1 in the airport terminal area, before treatment with the disclosed composition (referred to as CMP also herein), readings taken over a five-minute interval.

FIG. 2 shows the graph depicting dust/particulate matter level at location 1 in the airport terminal area, after seven days of treatment with the disclosed composition (referred to as CMP also herein), readings taken over a five-minute interval.

FIG. 3 shows the graph depicting dust levels at location 5 in the airport terminal area, before treatment with the disclosed composition (referred to as CMP also herein), readings taken over a five-minute interval.

FIG. 4 shows the graph depicting dust/particulate matter level at location 5 in the airport terminal area, after seven days of treatment with the disclosed composition (referred to as CMP also herein), readings taken over a five-minute interval.

FIG. 5 shows the graph depicting dust levels at location 7 in the airport terminal area, before treatment with the disclosed composition (referred to as CMP also herein), readings taken over a five-minute interval.

FIG. 6 shows the graph depicting dust/particulate matter level at location 7 in the airport terminal area, after seven days of treatment with the disclosed composition (referred to as CMP also herein), readings taken over a five-minute interval.

FIG. 7 shows the graph depicting dust levels at location 1 in the hospital area, before treatment with the disclosed composition (referred to as CMP also herein), readings taken over a five-minute interval.

FIG. 8 shows the graph depicting dust/particulate matter level at location 1 in the hospital area, after seven days of treatment with the disclosed composition (referred to as CMP also herein), readings taken over a five-minute interval.

FIG. 9 shows the graph depicting dust levels at location 2 in the hospital area, before treatment with the disclosed composition (referred to as CMP also herein), readings taken over a five-minute interval.

FIG. 10 shows the graph depicting dust/particulate matter level at location 2 in the hospital area, after seven days of treatment with the disclosed composition (referred to as CMP also herein), readings taken over a five-minute interval.

FIG. 11 shows the graph depicting dust levels at location 1 in the garment manufacturing area, before treatment with the disclosed composition (referred to as CMP also herein), readings taken over a five-minute interval.

FIG. 12 shows the graph depicting dust/particulate matter level at location 1 in the garment manufacturing area, after seven days of treatment with the disclosed composition (referred to as CMP also herein), readings taken over a five-minute interval.

FIG. 13 shows the graph depicting dust levels at location 2 in the garment manufacturing area, before treatment with the disclosed composition (referred to as CMP also herein), readings taken over a five-minute interval.

FIG. 14 shows the graph depicting dust/particulate matter level at location 2 in the garment manufacturing area, after seven days of treatment with the disclosed composition (referred to as CMP also herein), readings taken over a five-minute interval.

FIG. 15 shows the graph depicting dust levels at location 3 in the garment manufacturing area, before treatment with the disclosed composition (referred to as CMP also herein), readings taken over a five-minute interval.

FIG. 16 shows the graph depicting dust/particulate matter level at location 3 in the garment manufacturing area, after seven days of treatment with the disclosed composition (referred to as CMP also herein), readings taken over a five-minute interval.

### DETAILED DESCRIPTION

The current invention discloses a novel water soluble, non-toxic, biodegradable, particle-binding composition. The invention particularly relates to compositions and methods of reducing pollution in ambient air. Definitions:

As used herein, the term “pollutant” refers to and includes outdoor and indoor air pollutants like mold, dust, mites, pollen, droppings and body parts from cockroaches, rodents, other insects, fine particulate matter (PM), pesticides, lead, gases or aerosols like carbon dioxide, carbon monoxide, nitrogen oxides, radon, volatile organic compounds like solvents, cleaning agents, formaldehyde.

Some non-limiting examples of the main indoor pollutants encompassed in the current invention are, biological contaminants, dust, fine particulate matter, environmental tobacco smoke (ETS), or second-hand smoke.

As used herein, the term “ambient air” refers to the air surrounding and being inhaled by the people and/or any other subjects inhabiting that area. The ambient air may be air in an indoor area, or an outdoor area. In an indoor area the ambient air may or may not be getting exchanged with outdoor air. The ambient indoor area air may or may not be getting filtered, or air conditioned by filtration units or air-conditioning units.

As used herein, the term “particle” refers to all particulate matter (PM) in the air or on surfaces in indoor or outdoor environment.

The particles can be of various sizes, ranging from 2.5 microns in diameter to 20 microns in diameter.

Particulate matter mostly comprises of a complex range of chemically and physically diverse substances that exist in the atmosphere as discrete suspended particles (liquid droplets or solids). PM is usually classified according to size, by its nominal median aerodynamic diameter (measured in micrometres or microns (μ)).

Particles 2.5 microns or lesser diameter are called “Fine particulate matter” or “soot”) may consist as a tiny solid or liquid droplet containing a variety of compounds, that is emitted from road and nonroad vehicles like construction vehicles.

PM with nominal diameters between 10 and 2.5 microns, designated as PM_{10-2.5}and referred to as thoracic coarse particles; PM with nominal diameters less than 0.1 g and referred to as ultrafine particles (UFPs).

Particulate matter also includes PM with diameter of 4 microns, which is at many places referred to as “RESP” in the current disclosure. It may also be referred to as PM4.

One main source of PM2.5 is diesel engines in trucks, buses, and nonroad vehicles (e.g., marine, construction, agricultural, and locomotive). Diesel engines emit large quantities of harmful pollutants annually.

Particulate matter is associated with a variety of serious health effects, including lung disease, asthma, and other respiratory problems. In general, children are especially sensitive to air pollution because they breathe 50 percent more air per pound of body weight than adults. Fine particulate matter, or PM2.5, poses the greatest health risk, because it can pass through the nose and throat and become lodged in the lungs. These particles can aggravate existing respiratory conditions, such as asthma and bronchitis, and they have been directly associated with increased hospital admissions and emergency room visits for heart and lung disease, decreased lung function, and premature death. Short-term exposure may cause shortness of breath, eye and lung irritation, nausea, light-headedness, and possible allergy aggravations.

Dust is made up of particles in the air that settle on surfaces. Large particles settle quickly and can be eliminated or greatly reduced by the body's natural defence mechanisms. Small particles are more likely to be airborne and are capable of passing through the body's defences and entering the lungs. Many sources can produce dust including: soil, fleecy surfaces, pollen, lead-based paint, and burning of wood, oil, or coal.

Tobacco smoke consists of solid particles, liquid droplets, vapours, and gases resulting from tobacco combustion. Over 4,000 specific chemicals have been identified in the particulate and associated gases. The effects of tobacco smoke on smokers include rhinitis/pharyngitis, nasal congestion, persistent cough, conjunctival irritation, headache, wheezing, and exacerbation of chronic respiratory conditions. Second-hand smoke has been classified as a “Group A” carcinogen by EPA and has multiple health effects on children. It has also been associated with the onset of asthma, increased severity of or difficulty in controlling asthma, frequent upper respiratory infections, persistent middle-ear effusion, snoring, repeated pneumonia, and bronchitis.

Common biological contaminants include, but are not limited to, mould, dust mites, pet dander (skin flakes), droppings and body parts from cockroaches, rodents and other pests or insects, viruses, and bacteria. Many of these biological contaminants are small enough to be inhaled. Biological contaminants are, or are produced by, living things. Biological contaminants are often found in areas that provide food and moisture. Damp or wet areas such as cooling coils, humidifiers, condensate pans, or un vented bathrooms can be mouldy. Draperies, bedding, carpet, and other areas where dust collects may accumulate biological contaminants.

Mould, dust mites, pet dander, and pest droppings or body parts can trigger asthma. Biological contaminants, including moulds and pollens can cause allergic reactions for a significant portion of the population. Tuberculosis, measles, Staphylococcus infections, Legionella and influenza are known to be transmitted by air.

As used herein, the term di- and trivalent alcohols refers to compounds that are characterized by having 2 or 3 functional hydroxyl (—OH) groups and being soluble in water. The alcohols are volatile, and diffuse from the coated surface over time. Di- and trivalent alcohols give the coated surface more shine.

Examples of divalent and trivalent alcohols includes, but are not limited to, glycerol, monopropylene glycol (MPG), polyethylene glycol (PEG) and ethanol.

As used herein, “short chain triglyceride” and “short chain triacylglycerides” are used interchangeably. The term refers to the compounds formed by the esterification reaction of fatty acids with glycerol. Triglycerides comprised of fatty acid chains with from two to five carbon atoms are referred to as short chain triglycerides (“SCT”) and are invariably saturated carbon chains. The short-chain triglycerides are characterized by being able to act as both plasticizer and solvent while being water-soluble.

Examples of SCTs that may be used in the current invention include, but are not limited to, triacetin.

As used herein, the term “additive” refers to any compound that may be added to the composition to enhance any of its characteristics such as imparting it a pleasant fragrance, or making it more effective. An additive may be an emulsifier, fragrance imparting compound, or a colorant.

As used herein, the term “thickener” refers to a compound that may increase the viscosity of the composition disclosed herein. The final desired viscosity of the composition is 1 mm²/sec. Examples of thickeners that may be used for the current composition include, but are not limited to, xanthan gum and C10-C30 alkyl acrylate cross-polymer.

As used herein the term “neutralizer” refers to a compound that is added to the composition to neutralize the pH, so that the final pH of the composition is in the range of 5-7. Examples of neutralizers that can be used in the current invention include, but are not limited to, triethanolamine, 2-amino-2-methyl-1-propanol, tetrahydrozypropyl ethylenediamine, sodium hydroxide, and diisopropanolamine.

As used herein, the term “biodegradable” means that the product is biodegradable and does not pose any unacceptable risk to the environment.

As used herein, “certified dust meter” means a laboratory service performed according to a given standard.

As used herein, the term “coating” refers to “a thin film of 0.02 microns to 2 microns that is applied on any surface as particle-binding film, wherein the thickness of the coating depends on the concentration used and the type of flooring being treated”.

“Care of tine floors” means that “when applied, the composition will give the surface an oil like surface which will cause the surface to appear more shiny and able to withstand more wear and tear.
Examples of fine floors includes, but is not limited to, marble, vinyl, epoxy, treated wood floors, rubber floors.

Manually applying the coating means that one can use a mop for laying out the coating using the composition disclosed herein.

Using machines means that one can use a floor washing machine or a back sprayer for laying out coating of the disclosed composition.

Longer service life of the surface should be understood as the surface will look nicer for a longer time using particle coating than normal treatment of the floor, for example by traditional floor washing.

### EMBODIMENTS

All embodiments presented herein are exemplary in nature and a person skilled in the art would appreciate that the invention may be practiced in various other ways without deviating from scope of the invention.

One embodiment of the current invention is a water-soluble, particle binding composition comprising 10% to 90% w/w of di- and/or trivalent alcohols, 0.1 to 10% w/w of at least one thickener, 1 to 10% w/w of at least one short chain triglyceride, and optionally, 0.1 to 50% w/w of at least one additive.

In one embodiment, the composition further comprises water as a diluent.

In one embodiment, pH of the composition disclosed herein is in the range 5.5-7.

In one embodiment, the composition comprises a thickener, and the thickener is C10-C30 alkyl acrylate cross-polymer. Adding the thickener gives the pH of 5.5 -7 to the composition disclosed herein. In one embodiment, the thickener is neutralized with a neutralizer.

In one embodiment, the neutralizer is added at 0.1-1% w/w of the composition. In one embodiment, the neutralizer amount is adjusted so as to achieve the final pH of 5.5-7 of the final composition.

In one embodiment, the neutralizer is selected from the group consisting of triethanolamine, 2-amino-2-methyl-1-propanol, tetrahydrozypropyl ethylenediamine, sodium hydroxide, and diisopropanolamine.

In one embodiment, the neutralizer is 2-amino-2-methyl-1-propanol (referred to herein as AMP).

In one embodiment, short chain triglycerides may be present in the range of 1% to 10% weight, may be 1% -5% weight, or 1% -2% weight, or 5% -10% weight. In one embodiment, the composition is non-toxic to humans and animals.

In one embodiment, the composition disclosed herein is stable for at least 12, 24 months or 36 months after formulation.

In one embodiment, the composition binds particles in range of size 0.5-20 microns.

In one embodiment, the composition is applied as at least as one coating on a surface to reduce pollution of ambient air in proximity to the surface. In one embodiment, the at least one coating is removed and replaced by a fresh coating on the surface after 16-70 hours.

In one embodiment, the composition disclosed reduces pollution of ambient air in proximity to the coated surface by up to 90%, when applied at a frequency of at least one coating every 16-70 hours. In one embodiment, the composition disclosed reduces pollution of ambient air in proximity to the coated surface by up to 90%, when applied at a frequency of at least one coating every 16-70 hours. In one embodiment, the frequency of coating may change depending on the type of surface being coated, and the activity level in the ambient air proximal to the surface. In one embodiment, the frequency of coating might be once every one day, once every two days, once every three days, once every four days, once every five days, once every six days, or once every seven days. The coating may also be reapplied at frequency of less than one day, if there is high activity in the air ambient to the coated surface, or if the surface is accumulating particulate matter at a high rate.

In one embodiment, the at least one coating is at least 0.02 microns thick. In one embodiment, the at least one coating is 0.02-2 microns thick. In one embodiment, the at least one coating is removed by applying a water-based cleaning agent.

In one embodiment, the composition disclosed herein reduces pollution of ambient air in proximity to a surface coated by the composition.

In one embodiment, the composition disclosed herein reduces pollution of ambient air in proximity to a surface coated by the composition by binding and reducing movement of particles that come in contact with the coated surface.

In one embodiment, the composition reduces pollution of ambient air till up to a height of two meters from the surface that has been coated with the said composition. In one embodiment, the surface is made of any natural or man-made material, or a combination thereof.

In one embodiment, the composition is coated on a horizontal or vertical surface in contact with the ambient air.

In one embodiment, the surface is made of at least one natural material and the natural material is wood, bamboo, rubber, linoleum, cork, marble, granite, limestone, slate, or a combination thereof.

In one embodiment, the surface is made of at least one man-made material and the man-made material is vinyl, glass, leather, epoxy, cement, concrete or a combination thereof.

In one embodiment, the composition disclosed reduces pollution of ambient air in proximity to the coated surface by up to 90%, when applied at a frequency of at least one coating every 16-70 hours.

In one embodiment, the composition does not damage any surface on which it is coated. In one embodiment, coating with the composition disclosed herein imparts more durability, and sheen to any surface. The invention will hereby replace ordinary daily maintenance.

In one embodiment, the composition can be applied to any surface by any means, including both mechanical and/or manual means.

In one embodiment, the pollutants fall on all coated horizontal or vertical surfaces, especially when the movement of the ambient air subsides, and the composition comprising the coating sticks to the contamination that lands on the surfaces. This method converts all surfaces into a “filter”.

In one embodiment, the composition disclosed herein is applied to any horizontal surface in contact with the ambient air where pollution has to be reduced. In one embodiment, the composition disclosed herein is applied to any vertical surface in contact with the ambient air where pollution has to be reduced.

In one embodiment, the coating binds to the contamination/pollutants/PM. and when movement again occurs in the ambient air, the pollutants/PM sticks to the coated surface and does not swirl up again. In one embodiment, the pollutants and/or PM settles less in the corners and along walls and under furniture when at least one horizontal or vertical surface is coated with the composition disclosed herein.

In one embodiment, the coating on any surface, comprising the composition disclosed herein, is easily wiped off, or removed from the surface, whereby it is possible to apply a new coating on the same surface. In one embodiment, the coating is removed by just water.

In one embodiment, the coating makes the surfaces look shiny with regular usage, attracts the dust in all the joints and crevices and cleans the floor much better than most of the other cleaning products available in the market for floor or surface cleaning. In one embodiment, the coating does not have any deleterious effect on any surface. In one embodiment, the surfaces that are coated with the composition given herein, have increased durability compared to surfaces that are not coated with, or are infrequently coated with the composition disclosed herein.

In one embodiment of the current invention, the current invention encompasses coating of rough surfaces like concrete and asphalt, which give off pollution when they are being drilled, or are not yet set, or if there is any kind of construction work going one. Here, the coating will prevent the dust from rising from the pores of the surfaces and give the surfaces a longer life while preventing external contamination from rising to the level of respiration.

One embodiment of this current invention is that the dust/particulate matter cloud formed as a result of activity and movement is removed and restricted due to the coating property and prevents the dust from rising in various industries and landfills.

In one embodiment, the PM is removed from ambient air up to 90% at a level, up to a height of at least 2 meters above the coated surface, or till a distance of at least 2 meters from the coated surface. This is a continuous process as the next level of particulate matter comes lower, or settles on vertical surfaces, and the coated surface is actively working to bind the particulate matter.

In one embodiment, the particulate matter/pollutants sticking to the coating on a surface are removed along with the coating, when the coating is removed from the surface. Thus, the existing contaminates/PM are removed before a fresh coating comprising the composition is applied. In one embodiment, the coating is applied in a layer of 0.02 microns to 2 microns thickness. which can bind the contamination that come into contact with it. In one embodiment, this decreases the amount of PM/pollutants reaching the airways, and thus decreases the amount of PM being inhaled by people coming into contact with the ambient air.

In one embodiment, the particles/particulate matter, pollutants encompassed in the present invention can be indoor or outdoor allergens.

In one embodiment, the given composition binds and reduces amount of aerosols, dust and sand in the ambient air.

In one embodiment, the indoor allergens are dust mites.

One embodiment of the current invention is a method of reducing pollution of ambient air , the method comprising the steps of applying at least one coating of a water-soluble, particle-binding composition to a surface in proximity to the ambient air, wherein the composition comprises 10% to 90% w/w of di- and trivalent alcohols , 0.1 to 10% w/w of at least one thickener, 1 to 10% w/w of at least one short chain triglyceride, and optionally, 0.1 to 50% w/w of at least one additive. In one embodiment, it comprises 1-30% water.

In one embodiment, the method further comprises the step of removing the coating from the surface and reapplying a fresh coating after a period of 16-70 hours.

In one embodiment, the composition disclosed herein can be used on carpets, hard surfaces or wood.

In one embodiment, use of the current composition on floors or indoor surfaces, increases HEPA filters life in the filtration systems installed indoors. In one embodiment, HVAC usage of power and cost of electricity reduces anywhere between 10-20% as air is purer, and does not be needed to be changed as often.

In one embodiment, in case of higher dust inflow from the outside, the dust in the indoor ambient air is controlled faster at the floor level as opposed to getting into the HVAC system.

In one embodiment, with AHU's when deploying fresh air , there is a stimulation/movement of the particles/particulate matters, and airborne particles/dust mites carrying potential bacteria and viruses ,usually get blown around more and have a higher propensity to contaminate the fresh air at breathing level and may enter the nasal tracts. With the composition disclosed herein, the floor effectively attracts and cleans the air continuously so this risk and potential incidence risk is mitigated.

In one embodiment, the composition disclosed herein is food safe and has no risk of contamination to foods or other consumables.

In one embodiment, the composition disclosed herein is formulated as gel, spray or liquid form.

In one embodiment, the dilution of the composition done in water for the final application/ coating is varied according to the final requirement, or the level of pollution in the air ambient to the surface being coated. For example, the dilution can vary from 2% to 8% in water for different surfaces, and depending on the level of pollution in the ambient air.

In one embodiment, the kinematic viscosity of the composition disclosed herein is at least 1 mm²/s at room temperature.

### EXAMPLES

### Example 1: Formulating the Composition Disclosed Herein

| Chemical name | Relative content |
|---|---|
| Glycerine | 40% |
| MPG (Monopropylene Glycol ) | 31% |
| PEG (Polyethylene glycol) | 10% |
| TRIACETIN | 9% |
| Ethanol | 1% |
| AMP (2-amino-2-methyl-1-propanol) | 0.1% |
| Water | 8-9% |

The formula is prepared by mixing ethanol and AMP and then mixing Triacetin and water, and add it to glycerin, PEG and water. This results in a product with a kinematic viscosity greater than 1 mm² /s at room temperature.

Example Evaluation of dust reduction in an airport after using the composition An airport is a high traffic area, where doors are frequently opened, bringing in dust, dust mites, microparticulate matter from the combustion fuels, and general PM of PM2.5, PM 1.0 and PM 10.

Number of days tested with the composition being applied every day to the floor: 7 days

Objective of the proof of concept (POC) : To assess the Purity of Air from an Indian airport in a metropolitan city, after using the compsotion disclosed herein, which is an 100% biodegradable, food safe, organic, non-allergen, pH neutral and water soluble product, and to be able to remove dust particles, dust mites, particulate matter and allergens and therefore leading to a purer airport reducing the likelihood of airborne diseases and viruses.

Methodology/Equipment/product/Manpower used: ⋅TSI Dust Trax 8533 (TSI Incorporated, Minnesota 55126 USA)—a certified ISIIRAE (Indian Society of Heating, Refrigerating and Air Conditioning Engineers) standard equipment globally accredited and certified monitoring equipment. The walk behind Machine was used by the service provider partners of the airport for cleaning purposes. The Walk Behind Machine used had a capacity of 40 litres of water. The process of cleaning was not changed or complicated from its usual process.

Dilution Ratio used for deploying the composition (referrred to herein after as CMP), through the walk behind floor cleaner CMP+Dilution in 40 Ltrs. of water—350 ml. Table 1 below shows dilution levels used in these seven days: No. of tests/Measurements done: 8

P.O.C. Test Period: Start Date of 1st testing: Sep. 16, 2020

### Completion Date of Testing: Sep. 23, 2020

The measurements were taken pre-usage of CMP on Day One between 12.00 Noon and 2.00 P.M.. The same measurements were taken post usage of CMP after 7 days usage, at identical time intervals, and with same factors . The indoor pollution was measured as mg/m³ as stipulated by CPCB (Central Pollution Control Board, ministry of environment, forst and climate change, Govt of India).

Graphs were plotted, as direct pictorial explanation of the readings taken by the Dust Trax monitor. This is a monitor that takes in the air for a period of 5 minutes and then the air is evaluated for the various PM levels. The graphs essentially give out the readings taken individually at intervals and the average for the 5 minutes as well where the graph is plotted then. The Dust Trax monitor is placed either on the floor or on surfaces at different heights from the floor, to take measurements.

The two readings are date and time at which the readings are taken, and the total values per mg/m³ (milligrams per cubic meter) as a measure.

The readings are taken to show what is the level of the PM in the air at the time of recording the test. The “max” value in the tables below show the maximum value recorded for a five-minute span, each measurement taken at interval of 5 seconds each. interval for a particular size of particulate matter (like PM 2.5, PM 4, PM 10 etc). The “avg” or average values show the average of the values recorded over a five-minute span, each measurement taken at interval of 5 seconds each. There are 60 values recorded in total. The “RESP” value shows PM4 values.

The experiments given herein were done to prove the efficacy vide the initial test in a stipulated condition and time and then post usage of at least 7 days.

Conditions on Day 1 at the airport: The traffic was slower yet readings were higher.

1) Low traffic of people 2) Low level of incoming flights 3) Low movement of passengers

Conditions on Day 7 (Sep. 23, 2020): The traffic was higher and efficacy was tested.

1) High traffic of people
2) High level of incoming flights—3 to 4 flights
3) High movement of passengers
4) Tests were done in between arrivals of flights

TABLE 1
Dilutions done for the composition
(CMP) in water before application

| Water (litres) | CMP (millilitres) |
|---|---|
| 10 | 75 |
| 20 | 150 |
| 40 | 350 |
| 100 | 750 |
| 200 | 1.5 |

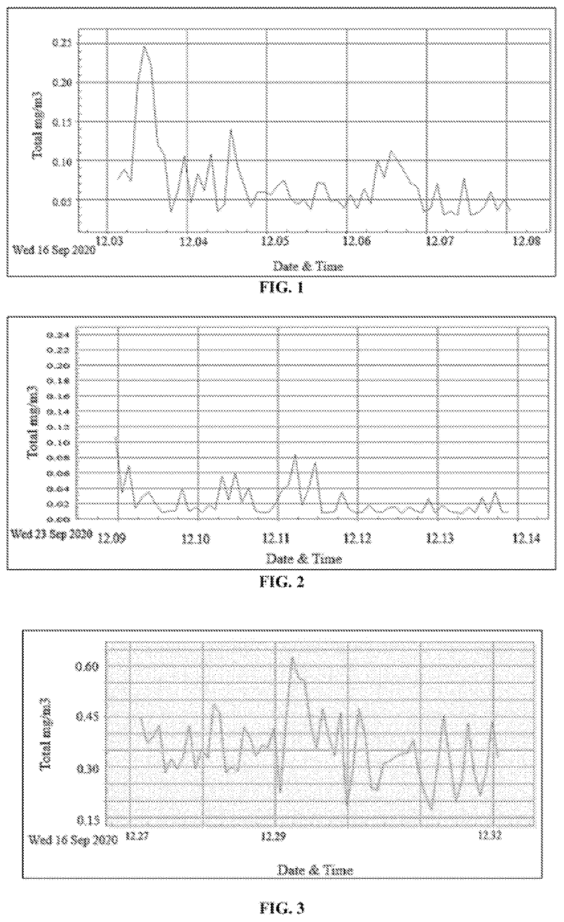

Test method: Step 1: Initial test was done for dust particles and pollutants—in the airport terminal on Sep. 16, 2020. Step 2: The next step was to mop the floor each time it is normally mopped by the housekeeping team with a certain percentage and concentrate of CMP. Step 3: Lastly, we tested for dust particles and pollutants in the Airport terminal on Sep. 23, 2020. These results were tabulated by our TSI Dust Trak device which is certified by ISHRAE standards in India. This process continued for 7 days continuously with our solution and we achieved great results in dust and particle reduction in the air which can also be seen below, and in FIGS. 1 and 2. No other chemical based product were used on the floor during these 7 days.

TABLE 2
Different locations in the airport used for taking measuremnets

| | Re- | Reduction |
|---|---|---|
| | duction | Max |
| Location | in Avg | (peaks) |
| 1. Main Bus Gate—Sliding door | 67.6% | 56.7% |
| 2. Below painting Near Planter | 87.6% | 77.5% |
| 3. Before Slope—Bclow Honeywell Sensor | 82.8% | 72.2% |
| 4. Before slope—Below Fire Extinguisher | 91.5% | 87.6% |
| 5. Near Planter—Back left maintenance door | 83.6% | 70.4% |
| 6. Near Glass—Top left comer | 84.4% | 83.4% |
| 7. Middle of slope—Between pillarsbelow planters | 87.8% | 81.5% |
| 8. Near sliding glass door—Terminal side | 55.2% | 51.9% |

The readings at various locations were captured with DustTrak DRX Instrument S/N: 8533192309 at a interval of 5 seconds with a total run time of 5 minutes.

Location 1: Reduction of dust and pollutants achieved: The tabulated results for the location 1, “near main entry gate” are shown below in Table 3 and 4. This is based on the 8 measurements taken pre and post CMP usage. Overall the dust and particulate pollution which customers and employees breathe in their day to day was reduced between 55.2%-91.5% with our product in various areas .

TABLE 3
Measurements before CMP application at location 1
(FIG. 1) Statistics (all values are in mg/m³)

| | PM1 | PM2.5 | RESP | PM 10 | TOTAL |
|---|---|---|---|---|---|
| Avg | 0.024 | 0.027 | 0.029 | 0.037 | 0.071 |
| Max | 0.031 | 0.034 | 0.040 | 0.076 | 0.247 |

TABLE 4
Measurements after CMP application
at location 1 (FIG. 2)
STATISTICS (all values are in mg/m³)

| | PM1 | PM2.5 | RESP | PM10 | TOTAL |
|---|---|---|---|---|---|
| Avg | 0.007 | 0.008 | 0.008 | 0.010 | 0.023 |
| Max | 0.010 | 0.011 | 0.012 | 0.020 | 0.107 |

Location 5: Near Planter, back left/Maintenance door

TABLE 5
Before CMP application; location 5 (FIG. 3)
STATISTICS (all values are in mg/m³)

| | PM1 | PM2.5 | RESP | PM10 | TOTAL |
|---|---|---|---|---|---|
| Avg | 0.029 | 0.037 | 0.047 | 0.117 | 0.354 |
| Max | 0.044 | 0.053 | 0.061 | 0.156 | 0.628 |

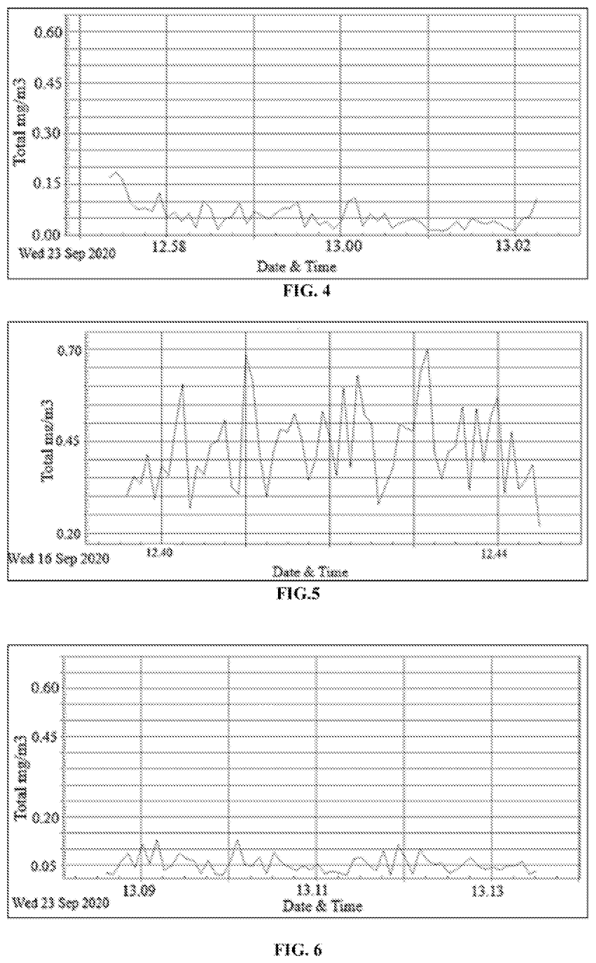

TABLE 6
After CMP application. Location 5: (FIG. 4)
STATISTICS (all values are in mg/m³)

| | PM1 | PM2.5 | RESP | PM10 | TOTAL |
|---|---|---|---|---|---|
| Avg | 0.008 | 0.010 | 0.011 | 0.020 | 0.058 |
| Max | 0.013 | 0.016 | 0.017 | 0.044 | 0.186 |

Location 7: Middle of Slope—Between Pillars—Below Planters

TABLE 7
before CMP application, location 7 (FIG. 5)
STATISTICS

| | PM1 | PM2.5 | RESP | PM10 | TOTAL |
|---|---|---|---|---|---|
| | (mg/m³) | (mg/m³) | (mg/m³) | (mg/m³) | (mg/m³) |
| Avg | 0.030 | 0.042 | 0.056 | 0.149 | 0.434 |
| Max | 0.040 | 0.050 | 0.068 | 0.202 | 0.699 |

TABLE 8
after CMP application at Location 7 (FIG. 6)
STATISTICS (all values are in mg/m³)

| | PM1 | PM2.5 | RESP | PM10 | TOTAL |
|---|---|---|---|---|---|
| Avg | 0.008 | 0.011 | 0.013 | 0.023 | 0.053 |
| Max | 0.012 | 0.014 | 0.018 | 0.038 | 0.129 |

Similar measurements and calculations were done for all the other locations indicated in Table 2.

Conclusions based on data from the observed values:

Based on tabulated results, the overall dust reduction we achieved as seen by the above data was varying between 55% to 91% as detailed in the graphs and charts above and are extrapolated directly from the TSI Monitor.

This result was achieved in a short period of usage of seven days only. With a continuous usage across the entire terminal even more uniform results can be expected.

This optimal level of reduction was achieved without any changes to the mopping routine at the airport terminal. So, no additional work was done or any changes made to the usage and deployment.

The floor type was Terrazo floor which is largely the floor used across the airport so can be concluded that the product efficacy would be visible and occur across all areas.

The area the product was tested in/at had a high traffic area through-out the testing cycle with large number of people with each flight coming in and constant opening and closing of the main doors. This is normal and with continued usage it will be even more effective readings as this was a seven-day usage reading only.

On the final day of monitoring the bus gate terminal had high traffic at the time of monitoring as testing was done between flights and the reduction was still achieved. So, it can be concluded that the product does not get affected by traffic and will perform continuously.

We also noticed that after usage of our solution the floor got a higher shine as if it was new and was looking much better as we could eradicate the dust out of the floor and make it shinier. This shine can be enhanced even more with a deep cleaning cycle and floor sheen and shine will be largely enhanced.

### Example 3

Location Type: Hospital

Date of 1^{st} testing: Jan. 17, 2019

Date of 2^{nd} Testing: Jan. 23, 2019

### Reduction of Dust Achieved

Location 1: Floor Waiting Area:

Average: 76.8%

Max: 71.8%

### Location 2: Ground Floor—Near Back Door

Average: 83%

Max: 80.5%

### Purpose and Method

We initially tested for dust particles in the ground floor waiting area and on the floor waiting are. These results were tabulated by our TSI Dust Trak device which is certified by ISHRAE standards in India. The readings at various locations were captured with DustTrak DRX Instrument S/N: 8533192309 at a interval of 5 seconds with a total run time of 5 minutes. The tabulated results are shown below.

The next step was to mop the floor each time it was being normally mopped as a regular routine, with a certain percentage and concentrate of the composition disclosed herein (CMP).

This process was continued for seven days continuously and we achieved great results in dust and particle reduction in the air which can also be seen below. Overall, the dust and particulate pollution which we breathe in our day to day to lives was reduced by 71%-81% with the composition disclosed herein (CMP).

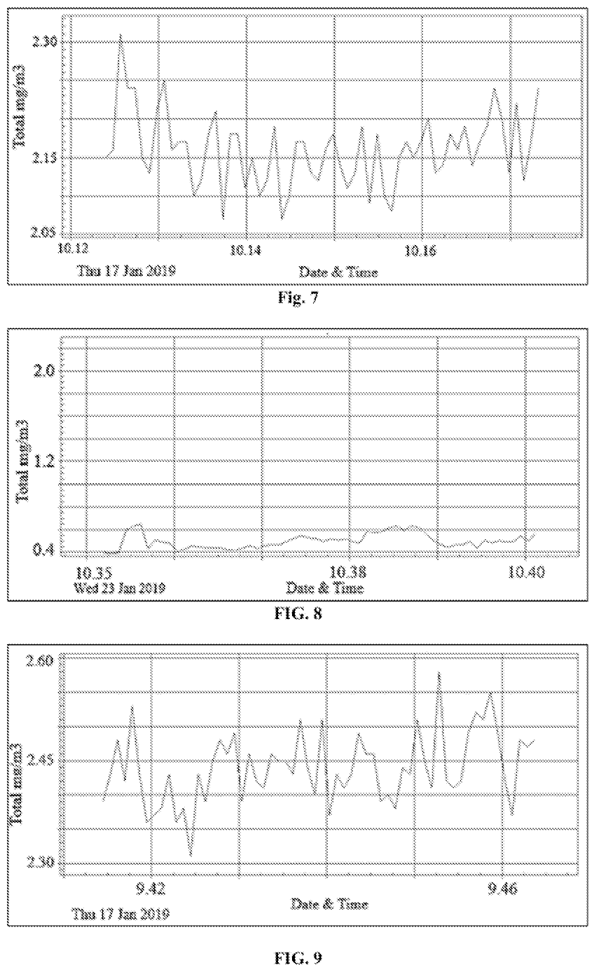

### Location 1: 1^{st} Floor Waiting Area (FIG. 7 and FIG. 8)

TABLE 9
shows data before CMP application (location 1, FIG. 7)
Statistics (all values are in mg/m³)

| | PM1 | PM2.5 | RESP | PM10 | TOTAL |
|---|---|---|---|---|---|
| Avg | 1.920 | 1.940 | 1.960 | 2.070 | 2.160 |
| Max | 1.980 | 2.000 | 2.020 | 2.190 | 2.310 |
| Date | Jan. 17, 2019 | Jan. 17, 2019 | Jan. 17, 2019 | Jan. 17, 2019 | Jan. 17, 2019 |
| Time | 10:12:34 | 10:12:34 | 10:12:34 | 10:12:34 | 10:12:34 |
| Min | 1.860 | 1.870 | 1.890 | 2.000 | 2.070 |

TABLE 10
shows data for location 1 measurements, after CMP application for 7 days.
Statistics (all values are in mg/m³)

| | PM1 | PM2.5 | RESP | PM10 | TOTAL |
|---|---|---|---|---|---|
| Avg | 0.408 | 0.410 | 0.413 | 0.448 | 0.500 |
| Max | 0.491 | 0.494 | 0.499 | 0.547 | 0.653 |
| Date | Jan. 23, 2019 | Jan. 23, 2019 | Jan. 23, 2019 | Jan. 23, 2019 | Jan. 23, 2019 |
| Time | 10:35:37 | 10:35:37 | 10:35:37 | 10:35:37 | 10:35:37 |
| Min | 0.370 | 0.372 | 0.373 | 0.385 | 0.390 |

### Location 2: Near Back Door, Ground Floor

TABLE 11
shows data and measurements before CMP use at location 2 (FIG. 9)
Statistics (all values are in mg/m³)

| | PM1 | PM2.5 | RESP | PM10 | TOTAL |
|---|---|---|---|---|---|
| Avg | 2.220 | 2.240 | 2.260 | 2.360 | 2.440 |
| Max | 2.300 | 2.320 | 2.340 | 2.440 | 2.580 |
| Date | Jan. 17, 2019 | Jan. 17, 2019 | Jan. 17, 2019 | Jan. 17, 2019 | Jan. 17, 2019 |
| Max Time | 09:45:37 | 09:45:37 | 09:45:37 | 09:45:17 | 09:45:17 |
| Min | 2.120 | 2.130 | 2.160 | 2.250 | 2.310 |

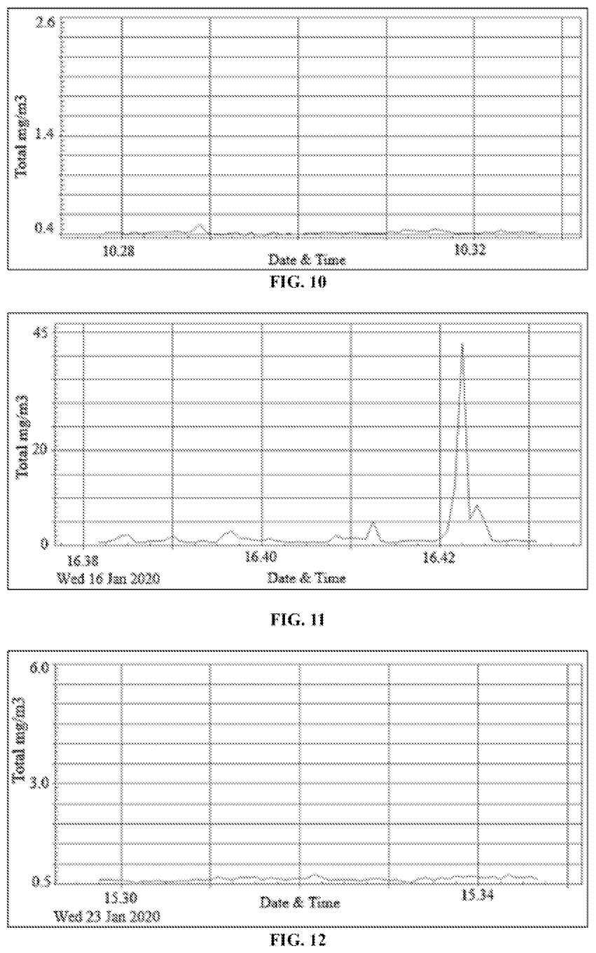

TABLE 12
shows data and measurements after seven days of CMP use (FIG. 10)
Statistics (all values are in mg/m³)

| | PM1 | PM2.5 | RESP | PM10 | TOTAL |
|---|---|---|---|---|---|
| Avg | 0.395 | 0.397 | 0.398 | 0.407 | 0.415 |
| Max | 0.445 | 0.447 | 0.448 | 0.465 | 0.504 |
| Date | Jan. 23, 2019 | Jan. 23, 2019 | Jan. 23, 2019 | Jan. 23, 2019 | Jan. 23, 2019 |
| Max Time | 10:28:53 | 10:28:53 | 10:28:53 | 10:28:53 | 10:28:53 |
| Min | 0.357 | 0.358 | 0.360 | 0.372 | 0.374 |

Result: The overall dust reduction we achieved as seen by the above report was varying between 71% to 81%. This level of reduction was achieved without any changes to the mopping routine at the office, which was three times of wet mopping and occasional dry mopping of the floor.

The floor type was: Tile on both the locations.

The ground floor and first floor waiting areas both have were high traffic areas throughout our testing cycle with huge amounts of people coming in and the main gate has no door on the ground floor and the back door too is open all the time, we still achieved the desired test result with reduction of dust.

As a recommendation we suggest that the doors are kept shut in order to further improve dust quality inside the hospital.

On the final day of monitoring both the areas had high traffic and the reduction was still achieved. We also noticed that after usage of our solution the floor got a shine as if it was new and was looking much better as we could eradicate the dust out of the floor. With dust and construction sites around there was high amount dust coming into the indoor area.

### Example 4: Effect of CMP application on Dust/particulate Matter Levels in a Garment Factory

### Type: Garment Manufacturing Unit

Date of 1^{st} testing: Jan. 16, /2019

### Date of 3^{rd} Testing: Jan. 23, 2019

Reduction of dust achieved:
In Staircase area (1^{st} Floor)

### Max: 98%

### Average: 74%

In Production area (near back Door):

### Max: 95.7%

### Average: 85%

In Inspection room:

### Max: 97.4%

### Average: 73%

The factory was initially tested for dust particles on the 1^{st} floor. We monitored dust and particle levels at three locations:
Location 1: On the staircase outside production floor
Location 2: In the inspection room
Location 3: Back of the production floor

These results were tabulated by our TSI Dust Trak device which is certified by ISHRAE standards in India. The tabulated results are shown below. The next step was to mop the floor each time it was normally mopped as part of the regular cleaning schedule with a certain percentage and concentrate of our dust binder solution (CMP). We mopped the floor with the industrial floor washing machines. This process continued for 7 days continuously and very good results were observed in dust and particle reduction in the air which is also tabulated below. Overall, the dust and particulate pollution was reduced by 73%-98% with our product.

### Monitoring Equipment Used: Dust Trax 8533

The readings at various locations were captured with DustTrak DRX Instrument S/N: 8533192309 at a interval of 5 seconds with a total run time of 5 minutes.

### Location 1: Staircase

TABLE 13
shows data and measurements on location 1, before CMP use (FIG. 11).
Statistics (all values in mg/m³)

| | PM1 | PM2.5 | RESP | PM10 | TOTAL |
|---|---|---|---|---|---|
| Avg | 1.010 | 1.030 | 1.090 | 1.600 | 2.360 |
| Max | 11.600 | 12.000 | 13.200 | 24.900 | 42.600 |
| Max Date | Jan. 16, 2019 | Jan. 16, 2019 | Jan. 16, 2019 | Jan. 16, 2019 | Jan. 16, 2019 |
| Max Time | 16:42:15 | 16:42:15 | 16:42:15 | 16:42:15 | 16:42:15 |
| Min | 0.490 | 0.495 | 0.508 | 0.564 | 0.613 |

TABLE 14
shows data and measurements on location 1, after seven days of CMP use (FIG. 12).
Statistics (all values in mg/m³)

| | PM1 | PM2.5 | RESP | PM10 | TOTAL |
|---|---|---|---|---|---|
| Avg | 0.492 | 0.498 | 0.508 | 0.561 | 0.620 |
| Max | 0.552 | 0.559 | 0.569 | 0.634 | 0.737 |
| Max Date | Jan. 23, 2019 | Jan. 23, 2019 | Jan. 23, 2019 | Jan. 23, 2019 | Jan. 23, 2019 |
| Max Time | 15:33:45 | 15:33:45 | 15:33:45 | 15:33:45 | 15:32:10 |
| Min | 0.442 | 0.447 | 0.453 | 0.483 | 0.519 |

### Location 2: Inspection Room

TABLE 15
measurements on location 2, before CMP use (FIG. 13).
Statistics (all values in mg/m³)

| | PM1 | PM2.5 | RESP | PM10 | TOTAL |
|---|---|---|---|---|---|
| Avg | 0.919 | 0.952 | 1.030 | 1.510 | 2.030 |
| Max | 7.730 | 8.250 | 9.700 | 17.800 | 24.500 |
| Max Date | Jan. 16, 2019 | Jan. 16, 2019 | Jan. 16, 2019 | Jan. 16, 2019 | Jan. 16, 2019 |
| Max Time | 16:47:58 | 16:47:58 | 16:47:58 | 16:47:58 | 16:47:58 |
| Min | 0.509 | 0.519 | 0.538 | 0.629 | 0.684 |

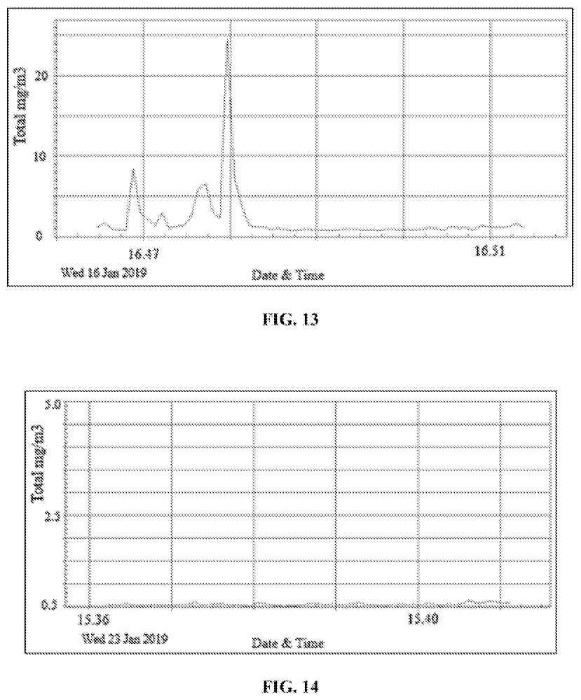

TABLE 16
shows data and measurements on location 2, after 7 days of CMP use (FIG. 14)
Statistics (all values in mg/m³)

| | PM1 | PM2.5 | RESP | PM10 | TOTAL |
|---|---|---|---|---|---|
| Avg | 0.473 | 0.478 | 0.486 | 0.518 | 0.547 |
| Max | 0.504 | 0.509 | 0.516 | 0.576 | 0.628 |
| Max Date | Jan. 23, 2019 | Jan. 23, 2019 | Jan. 23, 2019 | Jan. 23, 2019 | Jan. 23, 2019 |
| Max Time | 15:38:02 | 15:38:02 | 15:38:02 | 15:40:37 | 15:40:37 |
| Min | 0.441 | 0.446 | 0.455 | 0.483 | 0.495 |

### Location 3: Back of Production Area

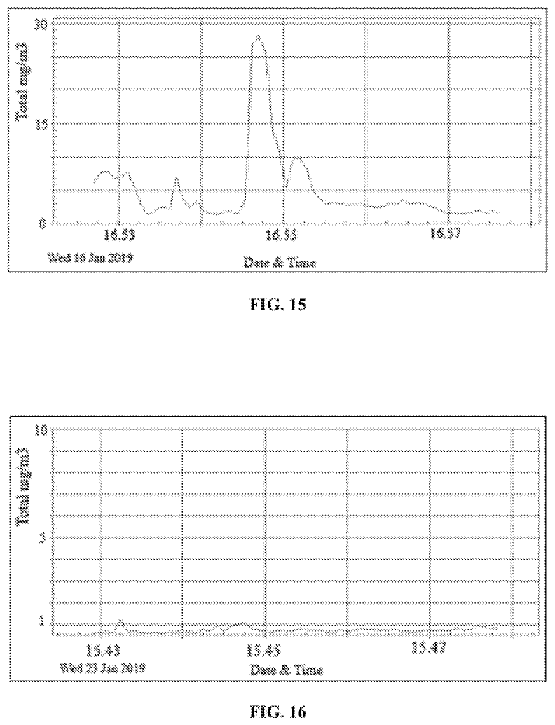

TABLE 17
measurements on location 3, before CMP use (FIG. 15).
Statistics (all values in mg/m³)

| | PM1 | PM2.5 | RESP | PM10 | TOTAL |
|---|---|---|---|---|---|
| Avg | 1.730 | 1.830 | 2.100 | 3.700 | 5.000 |
| Max | 7.990 | 8.350 | 9.580 | 19.600 | 28.200 |
| Max Date | Jan. 16, 2019 | Jan. 16, 2019 | Jan. 16, 2019 | Jan. 16, 2019 | Jan. 16, 2019 |
| Max Time | 16:54:37 | 16:54:37 | 16:54:37 | 16:54:42 | 16:54:42 |
| Min | 0.703 | 0.728 | 0.792 | 1.080 | 1.280 |

TABLE 18
shows measurements on location 3, after 7 days of CMP use (FIG. 16).
Statistics (all values in mg/m³)

| | PM1 | PM2.5 | RESP | PM10 | TOTAL |
|---|---|---|---|---|---|
| Avg | 0.525 | 0.532 | 0.546 | 0.632 | 0.747 |
| Max | 1.090 | 1.100 | 1.110 | 1.160 | 1.220 |
| Max Date | Jan. 23, 2019 | Jan. 23, 2019 | Jan. 23, 2019 | Jan. 23, 2019 | Jan. 23, 2019 |
| Max Time | 15:43:15 | 15:43:15 | 15:43:15 | 15:43:15 | 15:43:15 |
| Min | 0.466 | 0.472 | 0.481 | 0.536 | 0.583 |

### Result:

Overall dust reduction that was achieved as seen by the above data was varying between 73%-98%. This level of reduction was achieved without any changes to the mopping routine at the factory, which was one time of wet mopping of the production floor each day with industrial floor washing machines.

The floor type was: marble in the production area.

The area had high traffic and high production was being done at the time of all tests.

The back door also had continuous opening and closing. This use of the composition CMP disclosed herein, resulted in a significant dust and particle reduction.

It was also noticed that after usage of our solution the floor got a shine as if it was new and was looking much better as we could eradicate the dust out of the floor.

We claim:

1. A water-soluble, particle binding composition comprising 10% to 90% w/w of di- and/or trivalent alcohols, 0.1 to 10% w/w of at least one thickener, 1 to 10% w/w of at least one short chain triglyceride, and optionally, 0.1 to 50 w/w of at least one additive.

2. The composition of claim 1, wherein pH of the composition is in the range 5.5-7.

3. The composition of claim 1, wherein the thickener is C10-C30 alkyl acrylate cross-polymer.

4. The composition of claim 2, wherein the thickener is neutralized with a neutralizer.

5. The composition of claim 4, wherein the neutralizer is selected from the group consisting of triethanolamine, 2-amino-2-methyl-1-propanol, tetrahydrozypropyl ethylenediamine, sodium hydroxide, and di isopropanolamine.

6. The composition of claim 5, wherein the neutralizer is 2-amino-2-methyl-1-propanol.

7. The composition of claim 1, wherein it is non-toxic to humans and animals.

8. The composition of claim 1, wherein the composition is stable for at least 12 months after formulation.

9. The composition of claim 1, wherein it binds particles in range of size 0,5-20 microns.

10. The composition of claim 1, wherein it is applied as at least as one coating on a surface to reduce pollution of ambient air in proximity to the surface.

11. The composition of claim 10, wherein it reduces pollution of ambient air in proximity to a surface coated by the composition.

12. The composition of claim 11, wherein the at least one coating is removed and replaced by a fresh coating on the surface after 16-70 hours.

13. The composition of claim 11, wherein the at least one coating is at least 0.2 microns thick.

14. The composition of claim 12, wherein it reduces pollution of ambient air in proximity to a surface coated by the composition by binding and reducing movement of particles that come in contact with the coated surface.

15. The composition of claim 12, wherein it reduces pollution of ambient air till up to a height of two meters from the surface that has been coated with the said composition.

16. The composition of claim 12, wherein it reduces pollution of ambient air in proximity to the coated surface by up to 90% , when applied at a frequency of at least one coating every 16-70 hours.

17. The composition of claim 16, wherein the particles are indoor or outdoor allergens.

18. The composition of claim 17, wherein the indoor allergens are dust mites.

19. The composition of claim 11, wherein the surface is made of any natural or man-made material, or a combination thereof.

20. A method of reducing pollution of ambient air , the method comprising the steps of applying at least one coating of a water-soluble, particle-binding composition to a surface in proximity to the ambient air, wherein the composition comprises 10% to 90% w/w of di- and trivalent alcohols , 0.1 to 10% w/w of at least one thickener , 1 to 10% w/w of at least one short chain triglyceride, and 0.1 to 50% w/w of at least one additive.

21. The method of claim 20, wherein the method further comprises the step of removing the coating from the surface and reapplying a fresh coating after a period of 16-70 hours.

22. The method of claim 20, wherein no other cleaner is used on the floor to achieve the reduction in pollution of ambient air.
